(19) United States
(12) Patent Application Publication
(10) Pub. No.: US 2024/0225006 A9
(43) Pub. Date: Jul. 11, 2024

(54) METHOD OF ANTIBACTERIAL AND ANTIVIRAL SURFACE TREATMENT OF FLEXIBLE COVER MATERIALS AND COVER MATERIALS OBTAINED WITH THIS METHOD

(71) Applicant: GRUPPO MASTROTTO S.P.A., Arzignano (VI) (IT)

(72) Inventor: Luca BONALDO, Mira (VE) (IT)

(73) Assignee: GRUPPO MASTROTTO S.P.A., Arzignano (VI) (IT)

(21) Appl. No.: 18/269,148

(22) PCT Filed: Dec. 23, 2021
(86) PCT No.: PCT/IB2021/062267

§ 371 Date: Jun. 22, 2023

(30) Foreign Application Priority Data
Dec. 23, 2020 (IT) 102020000032255

(51) Int. Cl. A01N 59/16; A01N 25/10; A01N 59/00; A01P 1/00

(52) U.S. Cl. CPC A01N 59/16; A01N 25/10; A01N 59/00; A01P 1/00

(57) ABSTRACT

A method of antibacterial and antiviral surface treatment of flexible cover sheet materials includes: providing a flexible cover sheet substrate; depositing at least one lower support layer on the upper surface of the substrate; providing an antibacterial and antiviral formulation comprising a liquid active sanitizing composition dispersed in a solvent containing a polymer-based solution; depositing the formulation on at least one lower support layer to form an upper antibacterial and antiviral active layer; heating the cover substrate to cause evaporation of the solvent of an upper active layer. The active sanitizing composition contains silver chloride and solid-state titanium dioxide of nanometric size and is intended, to inhibit proliferation of bacterial and viral pathogens on the surface of the substrate, while keeping the properties of the materials thereof unaltered.

### FIELD OF THE INVENTION

The present invention generally finds application in the tanning industry and particularly relates to a method of antibacterial and antiviral surface treatment of flexible cover materials, namely hides and skins.

### BACKGROUND ART

Chemical compounds with antibacterial and/or antiviral properties have been long known to prevent proliferation of pathogenic microorganisms to preserve a product for a longer time.

These compounds may be used in various industries, such as the agriculture, building, textile, wood and paper, cosmetics, food, leather and household product industries.

In recent years compounds containing silver have been widely used, since this element is known for its antibacterial, antiviral and antifungal properties.

Since ancient times silver has been used in medicine for treatment of wounds and diseases, but also for purification of food and water.

Namely, the dispersion of silver-based particles in a medium has afforded production of compounds capable of relatively quickly inhibiting and/or limiting proliferation of pathogens.

The action of silver on microorganisms is mainly due to enzymatic deactivation of oxygen metabolism, which ultimately leads to elimination of the bacterium.

For viruses, studies have shown that silver can attack the outer lipid wall, leading to the breakdown of the virus.

Furthermore, due to its oxidizing power, silver is also able to interfere with the functions of DNA and RNA chains.

The size of the silver particles in the dispersion greatly influences the effectiveness of the compound against pathogens.

In particular, since the activity of silver is inversely proportional to the particle size, dispersions with particles of nanometric size are desirable.

US2010330142 discloses a plurality of compositions comprising silver, in the form of metallic silver or its compound, and at least one additional biocidal active ingredient, to inhibit proliferation of a wide spectrum of microorganisms.

In one embodiment, the silver-based compound is silver chloride (AgCl), which is adsorbed on the surface of titanium dioxide particles (TiO₂) in a weight ratio of 0.1% to 75%.

This composition may be used in the finish for fabrics, hides, non-wovens and bandages. However, no mention is made about compatibility of the composition containing AgCl and TiO₂ with any other chemicals in the finish, and about methods to be used to apply the composition to fabrics.

In an attempt to at least partially overcome this limitation, WO201612900, by the Applicant hereof, discloses a method designed for finished leather, for providing self-sanitization and self-cleaning of surfaces in which two superimposed coating layers are spray deposited on the leather surface during finishing.

The first deposited layer comprises a film-forming polymer-filler compound, a flow additive compound, a crosslinking compound, an antioxidant compound and an aqueous dispersion.

A further layer, deposited on top of the first layer, comprises an aqueous-based flow additive auxiliary compound, a silicone emulsion, an aliphatic polymer in a solvent, a photo-catalyst compound, a water-repellent agent, solvent agents, wetting agents, dispersing agents, antifoam agents and a silver-containing biocidal compound.

The addition of the silver-containing biocidal compound to certain compatible chemicals ensures inhibition of bacterial proliferation on the leather surface, without prejudice to the mechanical and aesthetic properties of the leather itself.

A first drawback of this known solution is that different types of leather for which this method might not be appropriate are not considered.

A second drawback is that the method may be applied to a specific type of leather that may be used in multiple industries, such as automotive, furniture, leather goods, etc., in which the characteristics of the final product might not be guaranteed.

Finally, the method cannot account for proliferation of microorganisms other than bacteria on the leather surface.

### Technical Problem

In view of the prior art, the technical problem addressed by the present invention is to provide a method for effectively inhibiting the proliferation of bacterial and viral pathogens on the surface of a flexible cover substrate while maintaining the properties of the different substrate materials.

### DISCLOSURE OF THE INVENTION

The object of the present invention is to solve the above problem, by providing a method of surface treatment of flexible cover substrates, specifically hides and skins, that is highly efficient and considerably cost-effective.

A particular object of the present invention is to provide a method of surface treatment of flexible cover substrates that ensures a high, long-lasting antibacterial and antiviral protection.

Another object of the present invention is to provide a method of surface treatment of flexible cover substrates that requires very small amounts of a sanitizing agent to inhibit proliferation of bacterial and viral pathogens.

A further object of the present invention is to provide a method of surface treatment of flexible cover substrates that can be applied to different types of hides and skins.

Another object of the present invention is to provide a method of surface treatment of flexible cover substrates that does not affect the properties of hides and skins.

A further object of the present invention is to provide a method of surface treatment of flexible cover substrates that can provide finished products of superior quality suitable for use in various contexts.

Another object of the present invention is to provide a method of surface treatment of flexible cover substrates that can provide products complying with the requirements as set out by relevant standards for antibacterial and antiviral surface treatment.

A further object of the present invention is to provide a method of surface treatment of flexible cover substrates invention that can provide products with very little maintenance requirements during a medium or long service life.

Another object of the present invention is to provide a method of surface treatment of flexible cover materials that can be easily implemented.

These and other objects, as more clearly explained hereafter, are fulfilled by a method of antibacterial and antiviral surface treatment of flexible cover sheet substrates as defined in claim 1.

The method comprises at least the steps of providing a flexible cover sheet substrate selected from hides and skins, depositing at least one lower support layer on the top surface of the substrate, preparing an antibacterial and antiviral formulation comprising a liquid active sanitizing composition dispersed in a solvent containing a polymer-based solution, depositing the formulation on at least one lower support layer to form an active antibacterial and antiviral upper layer, heating the cover substrate to cause evaporation of the solvent of the upper active layer.

In one aspect of the invention, the active sanitizing composition contains silver chloride and solid-state titanium dioxide of nanometric size. Furthermore, the active sanitizing composition is 0.1% to 2.5% by weight, the solvent is 8% to 80% by weight and the polymer-based solution is 15% to 80% by weight, based on the total weight (100%) of the formulation depending on the use to which the treated cover substrate is intended.

In one embodiment concerning automotive substrates, the formulation of the upper active layer comprises 2% to 7% by weight of a polymer-based solution comprising polydimethyl siloxane (PDMS), 1% to 5% by weight of amino-functional silicone, 10% to 25% by weight of a first aqueous solution of opacifying polyurethane, 5% to 10% by weight of a second aqueous solution of high molecular size polyurethane, 10% to 25% by weight of an aqueous solution of aliphatic polyurethane with inorganic opacifiers, 5% to 10% by weight of a first aqueous solution of aliphatic polycarbonate, 1% to 5% by weight of a second aqueous solution of aliphatic polycarbonate, 0.1% to 0.4% by weight of polyether-siloxane, 0.1% to 0.3% by weight of polyether-siloxane with pyrolytic silica, based on the total weight (100%) of the formulation.

In addition, the formulation of this upper active layer comprises 20% to 40% by weight of water as a solvent, 0.5% to 2.5% by weight of an active sanitizing composition of silver chloride and titanium dioxide, and 1% to 7% by weight of sterically modified dipropylene diisocyanate (HDI) as crosslinking agents, and 0.5% to 2.5% by weight of hydrolyzed polycarbodiimide, based on the total weight (100%) of the formulation.

In this particular field of application, the lower support layer comprises 25% and 35% by weight of water as a solvent, 10% to 15% by weight of a hybrid polyether-polycarbonate-based polyurethane, 8% to 12% by weight of a polyether-based polyurethane, 3% to 7% by weight of polyester-based polyurethane, 30% to 40% of a mixture of polyethers and fumed silica and 3% to 7% by weight of hexamethylene diisocyanate (HDI), based on the weight (100%) of the lower support layer.

In another embodiment, suitable for use on substrates intended for furniture, the formulation of the upper active layer comprises 30% to 40% by weight of a third aqueous solution of opacifying polyurethane, 25% to 40% by weight of a fourth aqueous solution of opacifying polyurethane, 0.1% to 2% by weight of amino-functional silicone, based on the total weight (100%) of the formulation.

Furthermore, the formulation of the upper active layer comprises 15% to 35% by weight of water as a solvent, 0.1% to 1.5% by weight of an active sanitizing composition of silver chloride and titanium dioxide, and 0.5% to 2.5% by weight of aliphatic polyisocyanate as a crosslinking agent, based on the total weight (100%) of the formulation.

In this embodiment, the lower support layer comprises 20% to 35% by weight of water as a solvent, 10% to 20% by weight of protein wax, 35% to 60% by weight of an aqueous solution of polyacrylate, 0.1% to 1% by weight of an antifoam agent, 3% to 8% by weight of an adhesive aliphatic polyurethane, 3% to 8% by weight of an adhesive aromatic polyurethane, 0.1% to 2% by weight of an active sanitizing composition of silver chloride and titanium dioxide, 0.5% to 3% by weight of aliphatic polyisocyanate as a crosslinking agent, based on the weight (100%) of the lower support layer.

In a further embodiment suitable for use to substrates intended for footwear and leather goods, the formulation of the upper active layer comprises 50% to 80% by weight of water as a solvent, 0.1% to 1.5% by weight of an active sanitizing composition of silver chloride and titanium dioxide, and 15% and 25% by weight of a fifth aqueous solution of opacifying polyurethane, based on the weight (100%) of the formulation.

Conveniently, in this case the upper active layer may be deposited on a polyurethane-based lower support layer.

In another embodiment, the formulation of the upper active layer comprises 50% to 80% by weight of a polyester-based solution of aliphatic polyurethane, 0.1 to 1% by weight of propylene glycol monomethyl ether, 8% to 15% by weight of pigments, 8% to 15% by weight of a mixture of isopropyl alcohol, toluene and butyl acetate as a solvent, and 0.1% to 2% by weight of an active sanitizing composition of silver chloride and titanium dioxide, based on the weight (100%) of the formulation.

In this further specific embodiment, the lower support layer comprises 10% to 20% by weight of water as a solvent, 50% to 80% by weight of a first aqueous solution of polyether-based aliphatic polyurethane, 3% to 8% by weight of a second aqueous solution of polyether-based aliphatic polyurethane, 0.1% to 1% by weight of a first mixture of vaseline oil and paraffin distillate as an antifoam agent, 0.1% to 1.5% by weight of 3-(polyoxyethylene)propylheptamethyltrisiloxane as a leveling agent, 8% to 15% by weight of pigments, 0.1% to 2% by weight of an active sanitizing composition of silver chloride and titanium dioxide, and 1% to 5% by weight of polyisocyanate as a crosslinking agent, based on the weight (100%) of the lower support layer.

Furthermore, the aforementioned lower support layer overlies at least one first bottom layer which comprises which comprises 50% to 70% by weight of a third aqueous solution of polyether-based aliphatic polyurethane, 3% to 8% by weight of a fourth aqueous solution of polyether-based aliphatic polyurethane, 10% to 20% by weight of water, 0.1% to 2% by weight of a second mixture of vaseline oil and paraffin distillate as an antifoam agent, 0.1% to 2.5% by weight of 3-(polyoxyethylene)propylheptamethyltrisiloxane as a leveling agent, 10% to 20% by weight of pigments, 0.1 to 2% by weight of an active sanitizing composition of silver chloride and titanium dioxide, and 2% to 7% by weight of polyisocyanate as a crosslinking agent, based on the weight (100%) of the first bottom layer.

Finally, this first bottom layer overlies at least one second bottom layer which comprises 60% to 85% by weight of an aqueous solution of polyether-based aliphatic polyurethane, 0.5% to 2.5% by weight of modified polyurethane, 0.1% to 1% by weight of a third mixture of vaseline oil and paraffin distillate as an antifoam agent, 0.1% to 1% by weight of 3-(polyoxyethylene)propylheptamethyltrisiloxane as a leveling agent, 10% to 20% by weight of pigments, and 1.5% to 5% by weight of polyisocyanate as a crosslinking agent, based on the weight (100%) of the second bottom layer.

Advantageous embodiments of the invention are as defined in the dependent claims.

### BRIEF DESCRIPTION OF THE DRAWINGS

Further features and advantages of the invention will be more apparent from the detailed description of a few preferred, non-exclusive embodiments of a method of surface treatment of flexible cover materials, of the skin or hide type, which are described as non-limiting examples with the help of the annexed drawings, in which:

FIG. 1 shows a sectional schematic view of a finished product according to a first embodiment;

FIG. 2 shows a sectional schematic view of a finished product according to a second embodiment;

FIG. 3 shows a sectional schematic view of a finished product according to a third embodiment;

FIG. 4 shows a sectional schematic view of a finished product according to a fourth embodiment.

### DETAILED DESCRIPTION OF A PREFERRED EXEMPLARY EMBODIMENT

The method of antibacterial and antiviral surface treatment of flexible cover sheet materials essentially comprises at least the following steps.

First, a flexible cover sheet substrate of the skin or hide type, generally referenced S, is provided.

At least one lower support layer 2, 2′, 2″, 2′″ is deposited on the top surface of the substrate S.

Next, an antibacterial and antiviral formulation is provided, which comprises a liquid active sanitizing composition dispersed in a solvent that contains a polymer-based solution.

In a well-known manner, all the components of the formulation are first appropriately dosed and then mechanically mixed together to obtain a homogeneous formulation.

Then, the formulation is deposited on at least one lower support layer 2, 2′, 2″, 2′″ to form an upper antibacterial and antiviral active layer 1, 1′, 1″, 1′″.

Finally, the cover substrate S is heated to cause evaporation of the solvent of the upper active layer 1, 1′, 1″, 1′″.

Advantageously, the liquid active sanitizing composition contains silver chloride (AgCl) and solid titanium dioxide (TiO₂) of nanometric size.

This composition consists of a saturated AgCl solution in which particles of TiO₂ (also known as titania) are dispersed, to form clusters of titania with AgCl on its surface.

Generally, these clusters have average sizes in the order of hundreds of nanometers.

Therefore, the antibacterial and antiviral activity of silver is enhanced due to the reduced size of the clusters, which increase its reactivity toward the organic components of bacteria and viruses.

Due to the strong activity of the AgCl— and titania-based sanitizing composition, a few micrometers of the upper active layer 1, 1′, 1″, 1′″ are sufficient to obtain a surface with high antibacterial and antiviral properties.

Preferably, the thickness of this upper active layer 1, 1′, 1″, 1′″ of the formulation ranges from 5 μm to 10 μm.

According to a particular aspect of the invention, the active sanitizing composition ranges from 0.1% to 2.5% by weight, the solvent ranges from 8% to 80% by weight, and the polymer-based solution ranges from 15% to 80% by weight based on the total weight (100%) of the formulation, depending on the use to which the treated cover substrate S is intended, to inhibit proliferation of bacterial and viral pathogens on the surface of the substrate S, while keeping the properties of the materials thereof unaltered.

With the above discussed method, the components that form the upper antibacterial and antiviral active layer 1, 1′, 1″, 1′″ as well as their concentration may be appropriately selected to adapt it to the finished product, whose characteristics will depend on its final use.

Namely, the method may be developed to produce flexible cover sheet substrates S with antibacterial and antiviral properties, mainly intended for use in the fields of automotive, furniture, footwear and leather goods, as further described below.

As shown in Table 1, which gives the values of the formulation of the upper active layer 1 for application to substrates S intended for use in the automotive industry, the formulation comprises 2% to 7% by weight of a polymer-based solution comprising polydimethylsiloxane (PDMS), 1% to 5% by weight of an amino-functional silicone, 10% to 25% by weight of a first aqueous solution of opacifying polyurethane, and 5% to 10% by weight of a second aqueous solution of high molecular size polyurethane, based on the total weight (100%) of the formulation.

Also, the solution of the upper active layer 1 comprises 10% to 25% by weight of an aqueous solution of aliphatic polyurethane with inorganic opacifying agents, 5% to 10% by weight of a first aqueous solution of aliphatic polycarbonate, 1% to 5% by weight of a second aqueous solution of aliphatic polycarbonate, 0.1% to 0.4% by weight of polyether-siloxane, 0.1% to 0.3% by weight of polyether-siloxane with fumed silica.

Furthermore, the formulation of this upper active layer 1 also comprises 20% to 40% by weight of water as a solvent, 0.5% to 2.5% by weight of an active sanitizing composition of silver chloride and titanium dioxide, and 1% to 7% by weight of sterically modified hexamethylene diisocyanate (HDI) as crosslinking agents, and 0.5% to 2.5% by weight of hydrolyzed polycarbodiimide.

Table 1 summarizes the characteristics of the formulation of the upper active layer 1 for application to flexible substrates S intended for use in the automotive industry.

TABLE 1

| Active agent | Function | Concentration |
|---|---|---|
| Polydimethylsiloxane | Touch improvement | 2-7% |
| (PDMS) | and abrasion | |
| | resistance | |
| Amino-functional | Touch improvement | 1-5% |
| silicone | | |
| First aqueous solution | Opacifier | 10-25% |
| of polyurethane | | |
| Second aqueous | High molecular size | 5-10% |
| solution of polyurethane | opacifier | |
| Aqueous solution of | Opacifier | 10-25% |
| aliphatic polyurethane | | |
| with inorganic | | |
| opacifiers | | |
| First aqueous solution | Improved abrasion | 5-10% |
| of aliphatic | resistance | |
| polycarbonate | | |
| Second aqueous | Improved abrasion | 1-5% |
| solution of aliphatic | resistance | |
| polycarbonate | | |
| Polyether-siloxane | Flow additive | 0.1-0.4% |
| Polyether-siloxane with | Antifoam agent | 0.1-0.3% |
| fumed silica | | |
| Water | Solvent | 20-40% |
| AgCl + TiO₂ | Sanitizing agent | 0.5-2.5% |
| Sterically modified | Crosslinking agent | 1-7% |
| hexamethylene | | |
| diisocyanate (HDI) | | |
| Hydrolyzed | Crosslinking agent | 0.5-2.5% |
| polycarbodiimide | | |

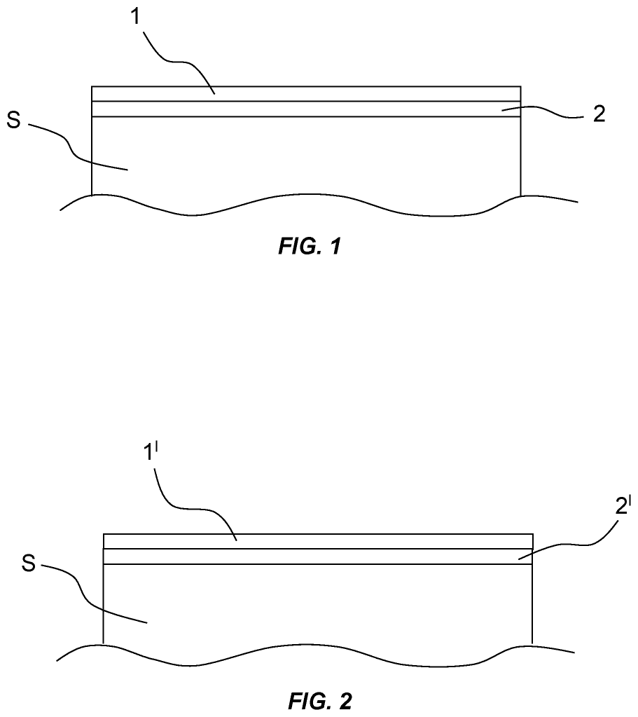

As shown in FIG. 1, in this first embodiment of the method, intended for use in the automotive industry, at least one lower support layer 2 is deposited between the upper active layer 1 and the surface of the flexible substrate S, to improve adhesion of the first layer 1 to the leather surface, and provide appropriate characteristics to the finished product.

Table 2 shows the characteristics and the composition of the lower support layer 2 for application to flexible substrates S intended for use in the automotive industry. Namely, the composition comprises 25% and 35% by weight of water as a solvent, 10% to 15% by weight of a hybrid polyether-polycarbonate-based polyurethane, 8% to 12% by weight of a polyether-based polyurethane, 3% to 7% by weight of polyester-based polyurethane, 30% to 40% of a mixture of polyethers and fumed silica, and 3% to 7% by weight of hexamethylene diisocyanate (HDI), based on the weight (100%) of the lower support layer 2.

TABLE 2

| Active agent | Function | Concentration |
|---|---|---|
| Water | Solvent | 25-35% |
| Hybrid polyether- | Improved gloss and | 10-15% |
| polycarbonate-based | hydrolysis | |
| polyurethane | | |
| Polyether-based | Adhesion promoter | 8-12% |
| polyurethane | | |
| Polyester-based | Adhesion promoter | 3-7% |
| polyurethane | | |
| Mixture of polyethers | Opacifier | 30-40% |
| and fumed silica | | |
| Hexamethylene | Crosslinking agent | 3-7% |
| diisocyanate (HDI) | | |

In the embodiment concerning materials intended for use in the automotive industry, the upper active layer 1 and the lower support layer 2 are preferably deposited on the surface of the flexible cover substrate S by spray coating.

Conveniently, the flexible sheet material S is conveyed on a belt along a line with layer deposition stations and drying stations.

First, the substrate S to be coated passes through a first station in which the support layer 2 is sprayed on the surface of the material preferably at about 25.83 g/m² (2.4 g/ft²) and at a pressure of about 0.70 atm.

Then, the substrate S thus coated is conveyed into a first heating and drying station in which it is kept at about 115° C. for about 35 seconds.

Subsequently, the dried substrate S moves to a second deposition line in which a plurality of nozzles are used to spray the upper active layer 1 on top of the dry lower support layer 2 preferably at about 96.88 g/m² (9 g/ft²) at a pressure of about 0.75 atm.

The process ends at a second drying station in which the treated substrate S is kept at 110° C. for 30 seconds.

Conveniently, the components of the upper active layer 1 and of the support layer 2 will be dosed to sum up to 100% by weight.

In a preferred embodiment intended for use in the automotive industry, the lower support layer 2 contains water at a concentration of 28.30% by weight, the hybrid polyether-polycarbonate-based polyurethane at a concentration of 13.20%, the polyether-based polyurethane at 9.40%, the polyester-based polyurethane at 5.70%, the mixture of polyethers and fumed silica at 37.70%, and hexamethylene diisocyanate at 5.70%.

On the other hand, the upper active layer 1 will preferably have a formulation containing polydimethylsiloxane at a concentration of 4.70% by weight, the amino-functional silicone at a concentration of 2.60%, the first aqueous solution of polyurethane at 17.50%, and the second aqueous solution of polyurethane at 8.70%.

Furthermore, the aqueous solution of aliphatic polyurethane with inorganic opacifying agents is contained at a weight of 17.50% by weight, the first aqueous solution of aliphatic polycarbonate at 7.4%, the second aqueous solution of aliphatic polycarbonate at 3.50%, the polyether-siloxane at 0.30%, the polyether-siloxane with fumed silica at 0.10%, water at 30.20%, the active sanitizing composition of AgCl and TiO₂ at 1%, the sterically modified hexamethylene diisocyanate at 5.50%, and the hydrolyzed polycarbodiimide at 1%.

Table 3 shows the composition and characteristics of the formulation of the upper active layer 1I for use in furniture.

TABLE 3

| Active agent | Function | Concentration |
|---|---|---|
| Third aqueous solution | Opacifier | 30-40% |
| of polyurethane | | |
| Fourth aqueous | Opacifier | 25-40% |
| solution of | | |
| polyurethane | | |
| Amino-functional | Touch improvement | 0.1-2% |
| silicone | | |
| Water | Solvent | 15-35% |
| AgCl + TiO₂ | Sanitizing agent | 0.1-1.5% |
| Aliphatic | Crosslinking agent | 0.5-2.5% |
| polyisocyanate | | |

In this case, the formulation of the upper active layer 1′ in applications on flexible cover substrates S for use in furniture, comprises 30% to 40% by weight of a third aqueous solution of opacifying polyurethane, 25% to 40% by weight of a fourth aqueous solution of opacifying polyurethane, 0.1% to 2% by weight of amino-functional silicone, based on the total weight (100%) of the formulation.

Furthermore, the formulation of this upper active layer 1′ further comprises 15% to 35% by weight of water as a solvent, 0.1% to 1.5% by weight of an active sanitizing composition of silver chloride and titanium dioxide, and 0.5% to 2.5% by weight of aliphatic polyisocyanate as a crosslinking agent, based on the total weight (100%) of the formulation.

As shown in FIG. 2, also in this second embodiment suitable for use in furniture products, an intermediate lower support layer 2′ should be deposited between the surface of the flexible substrate S and the upper active layer 1′, and have the characteristics as given in the following Table 4.

Here, the composition and characteristics of the support layer 2′ comprise 20% to 35% by weight of water as a solvent, 10% to 20% by weight of protein wax, 35% to 60% by weight of an aqueous solution of polyacrylate, and 0.1% to 1% by weight of an antifoam agent based on the weight (100%) of the lower support layer 2′.

Furthermore, the lower support layer 2′ further comprises 3% to 8% by weight of an adhesive aliphatic polyurethane, 3% to 8% by weight of an adhesive aromatic polyurethane, 0.1% to 2% by weight of an active sanitizing composition of silver chloride and titanium dioxide, and 0.5% to 3% by weight of aliphatic polyisocyanate as a crosslinking agent.

TABLE 4

| Active agent | Function | Concentration |
|---|---|---|
| Water | Solvent | 20-35% |
| Protein wax | Opacifier and reinforcer | 10-20% |
| Aqueous solution of | Binder | 35-60% |
| polyacrylate | | |
| Antifoam | Antifoam agent | 0.1-1% |
| Aliphatic polyurethane | Improved finish | 3-8% |
| | adhesion and color | |
| Aromatic polyurethane | Adhesion coat | 3-8% |
| AgCl + TiO₂ | Sanitizing agent | 0.1-2% |
| Aliphatic | Crosslinking agent | 0.5-3% |
| polyisocyanate | | |

In a preferred embodiment intended for use in furniture, the upper active layer 1′ and the lower support layer 2′ are deposited on the surface of a flexible substrate S by spray coating.

Conveniently, the sheet material S to be coated passes through a first deposition station in which a plurality of nozzles sprays the lower support layer Von the surface of the material preferably at about 107.64 g/m² (10 g/ft²) at a pressure of about 0.90 atm.

The substrate S thus coated is conveyed into a first drying station in which it is kept at 115° C. for 45 seconds.

Then, the upper active layer is deposited by the nozzles of a second deposition station at about 96.88 g/m² (9 g/ft²) and at a pressure of about 0.75 atm.

Finally, the treated material moves to a second drying station in which it is kept for 30 seconds at 110° C.

Preferably, for furniture applications, the lower support layer 2′ will have a composition with water at a weight concentration of 25.50%, the protein wax at a concentration of 12%, the aqueous solution of polyacrylate at 50.65%, the antifoam agent at 0.15%, the aliphatic polyurethane at 4.50%, the aromatic polyurethane at 5.70%, the active sanitizing composition of AgCl and TiO₂ at 0.5%, and the aliphatic polyisocyanate at 1%.

On the other hand, the upper active layer 1′ will preferably have a formulation with the third aqueous solution of polyurethane at a weight concentration of 37.20%, the fourth aqueous solution of polyurethane at a concentration of 35.50%, the amino-functional silicone at 0.50%, the water at 25%, the active sanitizing composition of AgCl and TiO₂ at 0.5%, and the aliphatic polyisocyanate at 1.30%.

Table 5 shows the formulation for an upper active layer 1″ designed to be applied to flexible sheet substrates S intended for use in footwear and leather goods.

Namely, the formulation of this upper active layer 1″ for application on flexible cover substrates intended for footwear and leather goods comprises 50% to 80% by weight of water as a solvent, 0.1% to 1.5% by weight of an active sanitizing composition of silver chloride and titanium dioxide, and 15% and 25% by weight of a fifth aqueous solution of opacifying polyurethane, based on the total weight (100%) of the formulation.

TABLE 5

| Active agent | Function | Concentration |
|---|---|---|
| Water | Solvent | 50-80% |
| AgCl + TiO₂ | Sanitizing agent | 0.1-1.5% |
| Fifth aqueous solution | Opacifier | 15-25% |
| of polyurethane | | |

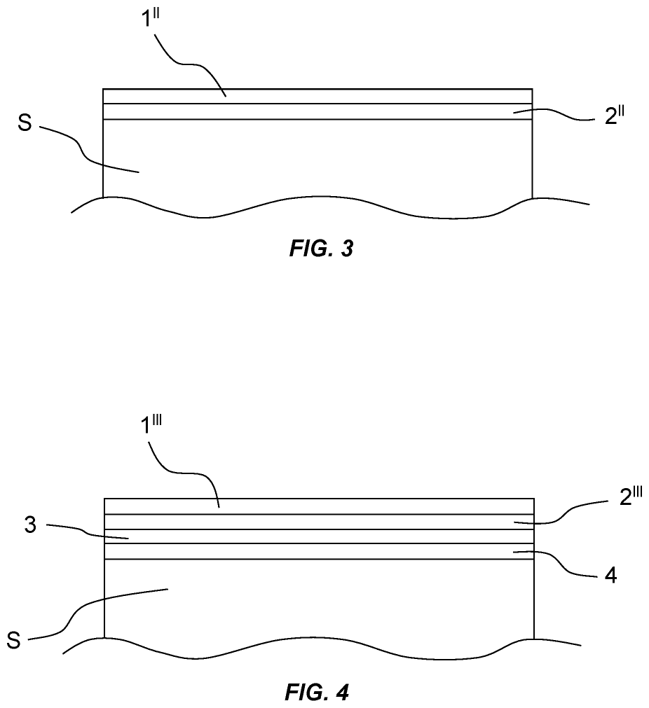

As shown in FIG. 3, also in this third embodiment suitable for use in footwear and leather goods, an intermediate polyurethane-based lower support layer 2″ should be deposited between the surface of the flexible substrate S and the upper active layer 1″.

Nevertheless, for certain products of this specific field, due to their reduced thickness, the deposition of the upper active layer 1″ only may be sufficient.

Like in the previous cases, the flexible material S to be spray coated will be conveyed on a belt to a deposition station in which the upper active layer 1″ is deposited preferably at about 43.06 g/m² (4 g/ft²) at a pressure of about 0.75 atm.

Then, the material moves to a drying station in which it is kept at 110° C. for 30 seconds.

Preferably, the upper active layer 1″ deposited on a substrate S intended for use in footwear and leather goods will have a formulation with water at a concentration of 79.50% by weight, the sanitizing active composition of AgCl and TiO₂ at a concentration of 0.5% by weight, and the fifth aqueous solution of polyurethane at a concentration of 20%.

In a fourth embodiment, as shown in FIG. 4, the antibacterial and antiviral surface layer may be applied to the flexible sheet material S by a bycast process.

The formulation of the upper active layer 1′″ for bycast deposition is given in the following Table 6.

TABLE 6

| Active agent | Function | Concentration |
|---|---|---|
| Solution of polyester- | Dispersant | 50-80% |
| based aliphatic | | |
| polyurethane | | |
| Propylene glycol | Silicone | 0.1-1% |
| monomethyl ether | | |
| Pigments | Dye | 8-15% |
| Mixture of isopropyl | Solvent | 8-15% |
| alcohol, toluene and | | |
| butyl acetate | | |
| AgCl + TiO₂ | Sanitizing agent | 0.1-2% |

As shown in Table 6, the formulation of the upper active layer 1′″ comprises 50% to 80% by weight of a solution of polyester-based aliphatic polyurethane, 0.1% to 1% by weight of propylene glycol monomethyl ether, and 8% to 15% by weight of pigments, based on the total weight (100%) of the formulation.

In addition, this upper active layer 1″′ comprises 8% to 15% by weight of a mixture of isopropyl alcohol, toluene and butyl acetate, and 0.1% to 2% by weight of an active sanitizing composition of silver chloride and titanium dioxide, based on the weight (100%) of the formulation.

This upper active layer 1′″ overlies at least one lower support layer 2′″ as shown in Table 7.

TABLE 7

| Active agent | Function | Concentration |
|---|---|---|
| Water | Solvent | 10-20% |
| First aqueous solution of | Dispersant | 50-80% |
| polyether-based aliphatic | | |
| polyurethane | | |
| Second aqueous solution of | Dispersant | 3-8% |
| polyether-based aliphatic | | |
| polyurethane | | |
| First mixture of vaseline oil | Antifoam agent | 0.1-1% |
| and paraffin distillate | | |
| 3-(polyoxyethylene) | Leveling agent | 0.1-1.5% |
| propylheptamethyltrisiloxane | | |
| Pigments | Dye | 8-15% |
| AgCl + TiO₂ | Sanitizing agent | 0.1-2% |
| Polyisocyanate | Crosslinking agent | 1-5% |

This lower support layer 2′″ comprises 10% to 20% by weight of water as a solvent, 50% to 80% by weight of a first aqueous solution of polyether-based aliphatic polyurethane, 3% to 8% by weight of a second aqueous solution of polyether-based aliphatic polyurethane, 0.1% to 1% by weight of a first mixture of vaseline oil and paraffin distillate as an antifoam agent, 0.1% to 1.5% by weight of 3-(polyoxyethylene)propylheptamethyltrisiloxane as a leveling agent, 8% to 15% by weight of pigments, 0.1% to 2% by weight of an active sanitizing composition of silver chloride and titanium dioxide, and 1% to 5% by weight of polyisocyanate as a crosslinking agent, based on the weight (100%) of the lower support layer 2′″.

On the other hand, the lower support layer 2″ overlies at least one first bottom layer 3, whose composition is given in Table 8, which comprises 50% to 70% by weight of a third aqueous solution of polyether-based aliphatic polyurethane, 3% to 8% by weight of a fourth aqueous solution of polyether-based aliphatic polyurethane, 10% to 20% by weight of water, 0.1% to 2% by weight of a second mixture of vaseline oil and paraffin distillate as an antifoam agent, 0.1% to 2.5% by weight of 3-(polyoxyethylene)propylheptamethyltrisiloxane as a leveling agent, 10% to 20% by weight of pigments, 0.1 to 2% by weight of an active sanitizing composition of silver chloride and titanium dioxide, and 2% to 7% by weight of polyisocyanate as a crosslinking agent, based on the weight (100%) of the first bottom layer 3.

TABLE 8

| Active agent | Function | Concentration |
|---|---|---|
| Third aqueous solution of | Dispersant | 50-70% |
| polyether-based aliphatic | | |
| polyurethane | | |
| Fourth aqueous solution of | Dispersant | 3-8% |
| polyether-based aliphatic | | |
| polyurethane | | |
| Water | Solvent | 10-20% |
| Second mixture of vaseline | Antifoam agent | 0.1-2% |
| oil and paraffin distillate | | |
| 3-(polyoxyethylene) | Leveling agent | 0.1-2.5% |
| propylheptamethyltrisiloxane | | |
| Pigments | Dye | 10-20% |
| AgCl + TiO₂ | Sanitizing agent | 0.1-2% |
| Polyisocyanate | Crosslinking agent | 2-7% |

Finally, the first bottom layer 3 overlies at least one second bottom layer 4, whose composition is given in Table 9, which comprises 60% to 85% by weight of an aqueous solution of polyether-based aliphatic polyurethane, 0.5% to 2.5% by weight of modified polyurethane, 0.1% to 1% by weight of a third mixture of vaseline oil and paraffin distillate as an antifoam agent, 0.1% to 1% by weight of 3-(polyoxyethylene)propylheptamethyltrisiloxane as a leveling agent, 10% to 20% by weight of pigments, and 1.5% to 5% by weight of polyisocyanate as a crosslinking agent, based on the weight (100%) of the second bottom layer 4.

TABLE 9

| Active agent | Function | Concentration |
|---|---|---|
| Aqueous solution of | Dispersant | 60-85% |
| polyether-based aromatic | | |
| polyurethane | | |
| Modified polyurethane | Rheology modifier | 0.5-2.5% |
| Third mixture of aseline oil | Antifoam agent | 0.1-1% |
| and paraffin distillate | | |
| 3-(polyoxyethylene) | Leveling agent | 0.1-1% |
| propylheptamethyltrisiloxane | | |
| Pigments | Dye | 10-20% |
| Polyisocyanate | Crosslinking agent | 1.5-5% |

Unlike spray coating, the bycast process includes first the deposition of the upper layer 1′″ and then the deposition of the layers 2′″, 3, 4 to the flexible substrate S.

The upper active layer 1′″ is deposited on a suitable release paper, and is homogeneously distributed on the surface of the paper at about 80 g/m² by means of a suitable coating blade.

This is followed by a drying step through an oven at a temperature of 90° C. for 100 seconds.

Then, the lower support layer 2′″ is likewise distributed on the upper active layer 1′″ at about 110 g/m², and then dried at 100° C. for 100 seconds.

This is followed by the deposition of the first bottom layer 3 at about 100 g/m² and dried again at 100° C. for 100 seconds.

Finally, the second bottom layer 4 is deposited at about 110 g/m², and will contact the surface of the flexible sheet substrate S to be coated, and after a last drying process at 100° C. for 180 seconds the release paper is removed, thus providing the finished product.

In a well-known manner, the release paper can be recovered and used again for another bycast process.

In a preferred embodiment of a surface with antibacterial and antiviral properties by the bycast process, the upper active layer 1′″ may have a formulation in which the solution of polyester-based aliphatic polyurethane has a concentration of 76.70% by weight, the propylene glycol monomethyl ether has a concentration of 0.30%, pigments a concentration of 11.40%, the mixture of isopropyl alcohol, toluene and butyl acetate has a concentration of 11.50%, and the sanitizing active composition of AgCl and TiO₂ of 0.1%.

The lower support layer 2′″ will preferably have a formulation in which water has a concentration of 12% by weight, the first aqueous solution of polyether-based aliphatic polyurethane has a concentration of 64.90% by weight, the second aqueous solution of polyether-based aliphatic polyurethane has a concentration of 6% by weight, the first mixture of vaseline oil and paraffin distillate has a concentration of 0.70% by weight, the 3-(polyoxyethylene)propylheptamethyltrisiloxane has a concentration of 0.70% by weight, pigments have a concentration of 13% by weight, the sanitizing composition of AgCl and TiO₂ has a concentration of 0.1% by weight, and polyisocyanate has a concentration of 3% by weight.

Otherwise, the first bottom layer 3 will preferably have a formulation in which the third aqueous of polyether-based aliphatic polyurethane will have a concentration of 64.90% by weight, the fourth aqueous solution of polyether-based aliphatic polyurethane will have a concentration of 6%, water will have a concentration of 12%, the second mixture of vaseline oil and paraffin distillate will have a concentration of 0.40%, 3-(polyoxyethylene)propylheptamethyltrisiloxane, pigments will have a concentration of 13%, the sanitizing composition of AgCl and TiO₂ will have a concentration of 0.1%, and polyisocyanate will have a concentration of 3%.

The second bottom layer 4, on the other hand, will preferably have a formulation in which the aqueous solution of polyether-based aromatic polyurethane will have a concentration of 82.50% by weight, the modified polyurethane will have a concentration of 1.80%, the third mixture of vaseline oil and paraffin distillate will have a concentration of 0.20%, 3-(polyoxyethylene)propylheptamethyltrisiloxane will have a concentration of 0.20%, pigments will have a concentration of 12.30%, and polyisocyanate will have a concentration of 3%.

### Antiviral Effectiveness Test

In order to test the antiviral effectiveness of the flexible materials S treated with the method as described above, three exemplary tests were carried out according to the international standard ISO 18184, as summarized in Table 10.

Samples of material with and without protective layer were cut into 20 mm squares, and H1N1 viruses were inoculated on their surface. After 2 hours at 25° C., viral counts were determined by TCID₅₀.

TABLE 10
Details of ISO 18184 antiviral tests on
samples with and without protective layer

| | | Viral count on | Viral count on | |
|---|---|---|---|---|
| | Viral count at | a sample | a sample with | |
| | the time of | without | protective layer | Antiviral |
| | inoculation | protective layer | after 2 hours | effective- |
| Sample | (TCID₅₀/ | after 2 hours | (TCID₅₀/ | ness |
| No. | sample) | (TCID₅₀/sample) | sample) | (%) |
| 1 | 11.2 × 10⁶ | 7.4 × 10⁶ | 6.3 × 10² | 99.99 |
| 2 | 12.6 × 10⁶ | 6.3 × 10⁶ | 7.4 × 10² | 99.99 |
| 3 | 12.6 × 10⁶ | 9.3 × 10⁶ | 6.3 × 10² | 99.99 |

It will be appreciated from Table 10 that all the samples tested and having the protective layer of the invention exhibit a 99.99% antiviral effectiveness.

### Antibacterial Effectiveness Test

Concerning the antibacterial activity of the materials treated with the method as described above, tests were carried out according to ASTM E 2180, ASTM E 2149, ISO 22196 and ISO 16187 standards, as shown in Tables 11-14.

In all types of tests, an agar containing a certain type of bacterium in an amount of about 1 ml is taken from a plate and pipetted to 20 mm square-shaped samples with and without the protective layer. After 24 hours under standard conditions, the bacterial count is determined.

The values for the ASTM E 2180 test carried out with Staphylococcus aureus and Klebsiella pneumoniae are given in the following Table 11 below and those for the ASTM E 2149 test carried out with Escherichia coli are shown in Table 12.

Tables 13 and 14 show the values obtained in the ISO 22169 tests on Escherichia coli and Staphylococcus aureus, and ISO 16187 on Staphylococcus aureus and Klebsiella pneumoniae respectively.

TABLE 11
Details of ASTM E 2180 test on
samples with and without protective layer

| | | Bacterial | Bacterial | |
|---|---|---|---|---|
| | | count on a | count on a | |
| | | sample | sample | |
| | Bacterial | without | with | |
| | count at | protective | protective | |
| | the time of | layer after | layer after | Antibacterial |
| | inoculation | 24 hours | 24 hours | effectiveness |
| Bacterium | (cfu/sample) | (cfu/sample) | (cfu/sample) | (%) |
| Staphylococcus | 1.7 × 10⁶ | 2.5 × 10⁶ | <20 | 99.99 |
| aureus | | | | |
| Klebsiella | 2.1 × 10⁶ | 8.2 × 10⁶ | <20 | 99.99 |
| pneumoniae | | | | |

TABLE 12
Details of ASTM E 2149 tests on
samples with and without protective layer

| | | Bacterial | | |
|---|---|---|---|---|
| | | count on a | Bacterial | |
| | | sample | count on a | |
| | Bacterial | without | sample with | |
| | count at the | protective | protective | |
| | time of | layer after | layer after | Antibacterial |
| | inoculation | 24 hours | 24 hours | effectiveness |
| Bacterium | (cfu/sample) | (cfu/sample) | (cfu/sample) | (%) |
| Escherichia | 3.0 × 10⁵ | 7.5 × 10⁵ | 35 | 99.99 |
| coli | | | | |

TABLE 13
Details of ISO 22169 tests on samples with and without protective layer

| | | Bacterial | Bacterial | |
|---|---|---|---|---|
| | | count on a | count on a | |
| | | sample | sample | |
| | Bacterial | without | with | |
| | count at | protective | protective | |
| | the time of | layer after | layer after | Antibacterial |
| | inoculation | 24 hours | 24 hours | effectiveness |
| Bacterium | (cfu/sample) | (cfu/sample) | (cfu/sample) | (%) |
| Escherichia | 2.1 × 10⁴ | 6.6 × 10⁵ | <10 | 99.99 |
| coli | | | | |
| Staphylococcus | 1 × 10⁴ | 9.2 × 10³ | <10 | 99.99 |
| aureus | | | | |

TABLE 14
Details of ISO 16187 tests on samples with and without protective layer

| | | Bacterial | Bacterial | |
|---|---|---|---|---|
| | | count on a | count on a | |
| | | sample | sample | |
| | Bacterial | without | with | |
| | count at the | protective | protective | |
| | time of | layer after | layer after | Antibacterial |
| | inoculation | 24 hours | 24 hours | effectiveness |
| Bacterium | (cfu/sample) | (cfu/sample) | (cfu/sample) | (%) |
| Staphylococcus | 6 × 10⁴ | 1.2 × 10⁶ | <10 | 99.99 |
| aureus | | | | |
| Klebsiella | 1.2 × 10⁵ | 1.4 × 10⁶ | <10 | 99.99 |
| pneumoniae | | | | |

It will be appreciated from Tables 11 to 14 that all the samples having the protective layer of the above method exhibit more than 99.9% antibacterial effectiveness.

It will be understood from the foregoing that the method of antibacterial and antiviral surface treatment of flexible cover substrates, such as hides and skins, according to the invention fulfills the intended purpose and objects. Namely, it can provide products with more than 99.9% antibacterial and antiviral effectiveness using very small doses of sanitizing agent.

This effectiveness is also due to the appropriately conceived and dosed compositions of the various layers.

It is known that, due to the different porosities of the layers, the penetration of polyurethane formulations produce different absorptions, resulting in uneven protective effectiveness against viruses and bacteria.

Conversely, with this invention, due to the uniform porosity of the layers and their uniform distribution with an appropriate dosage of the components in all application fields, a final product with high antibacterial and antiviral properties is obtained.

Also, the method may be conveniently used with materials designed for different applications without affecting the inherent properties of the treated substrates.

While the method of providing antibacterial and antiviral surfaces has been described with reference to spray coating and bycast deposition methods, other prior art known processes may be used to deposit at least one surface layer without departure from the scope of the invention.

Reference herein to “one embodiment” or “the embodiment” or “some embodiments” indicates that a particular characteristic or element that is being described is included in at least one embodiment of the inventive subject matter.

### INDUSTRIAL APPLICABILITY

The present invention may find application in industry, because it can be produced on an industrial scale in the tanning industry.

1. A method of antibacterial and antiviral surface treatment of flexible cover sheet materials, comprising:
providing a flexible cover sheet substrate (S) selected from hides or skins;
depositing at least one lower support layer (2, 2′, 2″, 2′″) on the top surface of said substrate (S);
providing an antibacterial and antiviral formulation, which comprises a liquid active sanitizing composition dispersed in a solvent containing a polymer-based solution;
depositing said formulation on at least one lower support layer (2, 2′, 2″, 2′″) to form an upper antibacterial and antiviral active layer (1, 1′, 1″, 1′″).
heating said cover substrate (S) to cause evaporation of the solvent of the upper active layer (1, 1′, 1″, 1′″);
wherein said active sanitizing composition contains silver chloride and solid-state titanium dioxide of nanometric size; and wherein said active sanitizing composition ranges from 0.1% to 2.5% by weight, said solvent ranges from 8% to 80% by weight, and said polymer-based solution ranges from 15% to 80% by weight based on the total weight of the formulation, depending on the use to which the treated cover substrate (S) is intended, to inhibit proliferation of bacterial and viral pathogens on the surface of the substrate (S), while keeping the properties of the materials thereof unaltered.

2. The method as claimed in claim 1, for application to a substrate (S) for use in the automotive industry, wherein the formulation of said upper active layer (1) comprises 2% to 7% by weight of a polymer-based solution comprising polydimethylsiloxane (PDMS), 1% to 5% by weight of amino-functional silicone, 10% to 25% by weight of a first aqueous solution of opacifying polyurethane, 5% to 10% by weight of a second aqueous solution of high molecular size polyurethane, 10% to 25% by weight of an aqueous solution of aliphatic polyurethane with inorganic opacifiers, 5% to 10% by weight of a first aqueous solution of aliphatic polycarbonate, 1% to 5% by weight of a second aqueous solution of aliphatic polycarbonate, 0.1% to 0.4% by weight of polyether-siloxane, 0.1% to 0.3% by weight of polyether-siloxane with fumed silica, based on the total weight of the formulation.

3. The method as claimed in claim 2, wherein a formulation of said upper active layer (1) comprises 20% to 40% by weight of water as a solvent, 0.5% to 2.5% by weight of an active sanitizing composition of silver chloride and titanium dioxide, and 1% to 7% by weight of sterically modified hexamethylene diisocyanate (HDI) as crosslinking agents, and 0.5% to 2.5% by weight of hydrolyzed polycarbodiimide, based on the total weight of the formulation.

4. The method as claimed in claim 2, wherein said lower support layer (2) comprises 25% and 35% by weight of water as a solvent, 10% to 15% by weight of a hybrid polyether-polycarbonate-based polyurethane, 8% to 12% by weight of a polyether-based polyurethane, 3% to 7% by weight of polyester-based polyurethane, 30% to 40% of a mixture of polyethers and fumed silica, and 3% to 7% by weight of hexamethylene diisocyanate (HDI), based on the total weight of said lower support layer (2).

5. The method as claimed in claim 1, for application to a substrate (S) for furniture, wherein the formulation of said upper active layer (1′) comprises 30% to 40% by weight of a third aqueous solution of opacifying polyurethane, 25% to 40% by weight of a fourth aqueous solution of opacifying polyurethane, 0.1% to 2% by weight of amino-functional silicone, based on the total weight of the formulation.

6. The method as claimed in claim 5, wherein the formulation of said upper active layer (1′) comprises 15% to 35% by of weight water as a solvent, 0.1% to 1.5% by weight of an active sanitizing composition of silver chloride and titanium dioxide, and 0.5% to 2.5% by weight of aliphatic polyisocyanate as a crosslinking agent, based on the total weight of the formulation.

7. The method as claimed in claim 5, wherein said lower support layer (2′) comprises 20% to 35% by weight of water as a solvent, 10% to 20% by weight of protein wax, 35% to 60% by weight of an aqueous solution of polyacrylate, 0.1% to 1% by weight of an antifoam agent, 3% to 8% by weight of an adhesive aliphatic polyurethane, 3% to 8% by weight of an adhesive aromatic polyurethane, 0.1% to 2% by weight of an active sanitizing composition of silver chloride and titanium dioxide, 0.5% to 3% by weight of aliphatic polyisocyanate as a crosslinking agent, based on the weight (100%) of said lower support layer (2′).

8. The method as claimed in claim 1, for application to a substrate (S) for use in footwear and leather goods, wherein the formulation of said upper active layer (1″) comprises 50% to 80% by weight of water as a solvent, 0.1% to 1.5% by weight of an active sanitizing composition of silver chloride and titanium dioxide, and 15% and 25% by weight of a fifth aqueous solution of opacifying polyurethane, based on the total weight of said formulation.

9. The method as claimed in claim 1, wherein the formulation of said upper active layer (1′″) comprises 50% to 80% by weight of a solution of polyester-based aliphatic polyurethane, 0.1% to 1% by weight of propylene glycol monomethyl ether, and 8% to 15% by weight of pigments, based on the total weight of said formulation.

10. The method as claimed in claim 9, wherein the formulation of said upper active layer (1″′) comprises 8% to 15% by weight of a mixture of isopropyl alcohol, toluene and butyl acetate, and 0.1% to 2% by weight of an active sanitizing composition of silver chloride and titanium dioxide, based on the total weight of said formulation.

11. The method as claimed in claim 9, wherein said lower support layer (2′″) comprise 10% to 20% by weight of water as a solvent, 50% to 80% by weight of a first aqueous solution of polyether-based aliphatic polyurethane, 3% to 8% by weight of a second aqueous solution of polyether-based aliphatic polyurethane, 0.1% to 1% by weight of a first mixture of vaseline oil and paraffin distillate as an antifoam agent, 0.1% to 1.5% by weight of 3-(polyoxyethylene)propylheptamethyltrisiloxane as a leveling agent, 8% to 15% by weight of pigments, 0.1% to 2% by weight of an active sanitizing composition of silver chloride and titanium dioxide, and 1% to 5% by weight of polyisocyanate as a crosslinking agent, based on the total weight of said lower support layer (2′″).

12. The method as claimed in claim 11, wherein said lower support layer (2′″) overlies at least one first bottom layer (3) which comprises 50% to 70% by weight of a third aqueous solution of polyether-based aliphatic polyurethane, 3% to 8% by weight of a fourth aqueous solution of polyether-based aliphatic polyurethane, 10% to 20% by weight of water, 0.1% to 2% by weight of a second mixture of vaseline oil and paraffin distillate as an antifoam agent, 0.1% to 2.5% by weight of 3-(polyoxyethylene)propylheptamethyltrisiloxane as a leveling agent, 10% to 20% by weight of pigments, 0.1 to 2% by weight of an active sanitizing composition of silver chloride and titanium dioxide, and 2% to 7% by weight of polyisocyanate as a crosslinking agent, based on the total weight of said first undercoat layer (3).

13. The method as claimed in claim 12, wherein said first bottom layer (3) overlies at least one second bottom layer (4) which comprises 60% to 85% by weight of an aqueous solution of polyether-based aliphatic polyurethane, 0.5% to 2.5% by weight of modified polyurethane, 0.1% to 1% by weight of a third mixture of vaseline oil and paraffin distillate as an antifoam agent, 0.1% to 1% by weight of 3-(polyoxyethylene)propylheptamethyltrisiloxane as a leveling agent, 10% to 20% by weight of pigments, and 1.5% to 5% by weight of polyisocyanate as a crosslinking agent, based on the total weight of said at least one second bottom layer (4).

14. The method as claimed in claim 10, wherein said layers (1″, 2′″, 3, 4) are deposited by a bycast process.
